(19) United States
(12) Patent Application Publication
(10) Pub. No.: US 2008/0270387 A1
(43) Pub. Date: Oct. 30, 2008

(54) METHOD AND SYSTEMS FOR SEARCHING AND DISPLAYING SEARCH RESULTS USING PROXIMITY CRITERIA

(75) Inventor: Christian Weitenberner, Playa Del Rey, CA (US)

Correspondence Address: SCHWEGMAN, LUNDBERG & WOESSNER, P.A., P.O. BOX 2938, MINNEAPOLIS, MN, 55402, US

(73) Assignee: Pakt, LLC, Playa Del Ray, CA (US)

(21) Appl. No.: 12/104,226

(22) Filed: Apr. 16, 2008

Related U.S. Application Data
(60) Provisional application No. 60/913,702, filed on Apr. 24, 2007.

(51) Int. Cl. G06F 17/30; G06F 7/06

(52) U.S. Cl. 707/5; 707/E17.069

(57) ABSTRACT

Search parameters and proximity criteria may be used to perform a proximity search. The proximity criteria may indicate a desired proximity among the search parameters in order for there to be a match. When there is a document that includes the search parameters that satisfy the proximity criteria, the search parameters in the document may be formatted.

### CROSS REFERENCE TO RELATED APPLICATIONS

This non-provisional United States (U.S.) patent application claims the benefit of provisional U.S. Patent Application No. 60/913,702 filed on Apr. 24, 2007 by inventor Christian Weitenberner, which is incorporated herein by reference in its entirety.

### FIELD OF INVENTION

This invention generally relates to the field of search technologies, and more specifically but not limited to searching using proximity criteria.

### BACKGROUND

The world of information is expanding geometrically and it becomes a matter of increasing difficulty to find information that matches our purposes. The evolution and sophistication of search tools, such as contextual and link based Internet search engines, has simplified the task of wading through countless possible outlets of information into a more manageable set. Searching through documents on a computer system has also been made more efficient using similar techniques. Companies are continuously developing to improve current search techniques.

### SUMMARY OF THE INVENTION

For some embodiments, methods and systems to search for documents using search parameters and proximity criteria may be disclosed. The proximity criteria may be expressed in terms of characters, words, phrases, sentences, paragraphs, pages, or documents. The proximity criteria may be a singular criterion or part of multiple criteria. When there are documents that include the search parameters, and the search parameters satisfy the proximity criteria, the documents may be included in the search results. The documents with more matches may be considered more relevant than the documents that have fewer matches. The documents may be displayed in an order of relevancy. The search parameters in these documents may be formatted. Other embodiments are also described.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an example of a process that may be used by a search engine to perform proximity search, in accordance with some embodiments.

FIG. 2 illustrates an example of one technique of providing the proximity criteria, in accordance with some embodiments.

FIG. 3 illustrates an example of another technique of providing the proximity criteria, in accordance with some embodiment.

FIG. 4 is an example that illustrates using proximity search in an application window, in accordance with some embodiments.

FIG. 5 is an example that illustrates using proximity search in a browser window, in accordance with some embodiments.

FIG. 6 illustrates an example of a computer system that includes logic that may be used, in accordance with some embodiments.

FIG. 7 illustrates an example of a system that may be used to perform search operations when connected to a network, in accordance with some embodiments.

### DETAILED DESCRIPTION

For some embodiments, methods and systems that may be used to search for documents using proximity criteria are disclosed. The proximity criteria may be used with search parameters. The search parameters may include one or more of keywords and key strings. For some embodiments, the search for the documents may be based on a dominant search parameter.

In the following detailed description, numerous specific details are set forth. However, it is understood that embodiments of the invention may be practiced without these specific details. In other instances, well-known circuits, structures, and techniques have not been shown in detail in order to not obscure the understanding of this description. These embodiments are described in sufficient detail to enable those of ordinary skill in the art to practice the invention. The following detailed description is, therefore, not to be taken in a limiting sense, and the scope of the invention is defined only by the appended claims.

### Introduction

Documents, especially those searchable on the Internet, may have multiple keywords and key strings. In some documents, the keywords and key strings may be positioned near one another. In some other documents, they may be far from one another. A keyword (e.g., “market”) may be a single word. A key string (e.g., “luxury cars”) may include one or more words and/or characters. Each keyword or key string may be used as a search parameter. There may be one or more search parameters.

A search engine may be used to search for the documents. The search engine may be a software application that may run in a stand-alone personal computer. The search engine may include a combination of hardware and/or software applications that may run in multiple computers. For example, the search engine may use the search parameters to search for matches in a document stored in a stand-alone personal computer. The search engine may use the search parameters to search for matches in multiple documents which may be accessible via the Internet.

The proximity criteria may enable the search engine to improve the quality of the search results. Using the proximity criteria, the search engine may look for a search parameter that is within proximity of another search parameter. The search parameters may be separated by, for example, sections, punctuation, words, markup formatting, etc.

When the search engine finds the search parameters in a document, and the positions of the search parameters relative to one another that satisfy the proximity criteria, there may be a match. The proximity criteria may be a weighted factor in determining the overall relevancy of search results.

### Search Process Using Proximity Criteria

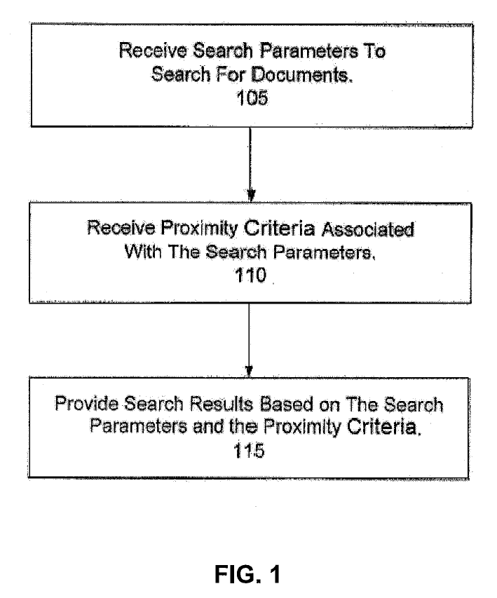

FIG. 1 illustrates an example of a process that may be used by a search engine to perform proximity search, in accordance with some embodiments. The processes may be implemented in software, hardware or a combination of both hardware and software. The processes may be performed using logic associated with a computer system such as, for example, a personal computer system. Other computer systems (e.g., smart phones with capabilities for accessing the Internet) that are designed to include logic to enable proximity search may also be used.

At block 105, search parameters may be specified and received by the search engine. The search parameters may be provided by a user. For example, a user may use browser software (e.g., Internet Explorer from Microsoft Corporation of Redmond, Wash.) to open a web site of a company that provides search services. An example of such a company is Google Inc. of Mountain View, Calif. The search parameters may include one or more keywords and/or key strings to search for documents.

The key strings may be automatically interpreted based on the relationships of the keywords. For example, a space between the keywords may be interpreted as each keyword being its own key string. One way to denote a key string, that is comprised of multiple words, is through the use of grouping characters such as, for example, the “+”, “[”, “]”, “{”, “}”, “(”, “)”, “″”, “′” characters. As an example, when the user types three keywords “baseball”, “Babe” and “Ruth”, this may indicate that the user wants to find the three keywords “baseball” “Babe” and “Ruth” within some proximity to one another. Alternatively, when the user types the keyword “baseball” and the key string “Babe Ruth”, this may indicate that the user wants to find “baseball” within some proximity to the key string “Babe Ruth”.

At block 110, the proximity criteria may be specified and received by the search engine. For some embodiments, the proximity criteria may be specified by the user. The proximity criteria may be expressed as either a high or a low contextual correlation between the search parameters when they are found within a document. A high proximity value may be interpreted as the search parameters are positioned near one another within the document. A low proximity value may be interpreted as the search parameters are positioned far from one other within the document. For example, a high proximity value may cause the search results to include documents where the search parameters are found within the same chapter and may exclude those documents having the same search parameters found in different chapters.

Different techniques may be used to allow the user to specify the proximity criteria. One example includes the use of a sliding bar that varies from a high proximity value to a low proximity value. Another example includes the use of a drop-down-box showing proximity values from “1” to “10” with the number “1” representing a high proximity value and the number “10” representing low proximity value. Another example includes the use of a menu with options ‘character’, ‘word’, ‘sentence’, ‘paragraph’, ‘section’, ‘page’, and ‘document’ where each option indicating a proximity value between the search parameters.

For some embodiments, when the search parameters include multiple keywords and key strings, there may be proximity criteria used between the keywords, and there may be different proximity criteria used between the key strings.

For some embodiments, the proximity criteria may be determined automatically by the search engine. For example, the search engine may use previously used proximity criteria, default proximity criteria, or commonly used proximity criteria. The search engine may also receive the proximity criteria from a database, cookie, file, HTTP (hypertext transport protocol) GET or PUT request, XML (extensible markedup language) service, email, or other network or Internet protocol data exchange.

At block 115, the search using the proximity criteria may be initiated. This may be caused, for example, by the user pressing a search selector or a link that causes the search to start. Alternatively, the search may be initiated automatically as the user is entering the search parameters. The search engine may use the proximity criteria to determine a distance between search parameters for each of the search parameters. The distance may be measured for each instance a search parameter is found within a document.

### Dominant Search Parameter

In general, each of the search parameters and its proximity with the other search parameters may be considered equally. For some embodiments, a search parameter may be considered to be dominant as compared to the other search parameters. When a search parameter is identified as a dominant parameter, the search engine may use the proximity criteria based from the dominant parameter. For example, the search engine may use the proximity criteria to calculate the proximity or distance between the dominant parameter and the non-dominant parameters. The search engine may calculate the proximity within the constraint of a document or a selected region of the document. It may be noted that the search engine may disregard or may give less consideration to the proximity among the non-dominant parameters when it searches for the documents.

### Unit of Distance

A unit of distance may be used to denote proximity value. The unit of distance may be measured in terms of characters, words, phrases, sentences, paragraphs, pages, or documents. Other units of distance may also be used. Some examples of units of distance may be “within the same sentence”, “within the same paragraph”, “within 200 characters”. Some other examples may include “low proximity”, “medium proximity” and “high proximity”, and the search engine may translate “low proximity” to within the same document, “medium proximity” to within the same chapter, and “high proximity” to within the same sentence.

### Relevancy of Search Results

When the search engine is to find documents that include the search parameters, those documents that are included in the search results may have different number of matches. For some embodiments, the documents that include more matches may be considered to be more relevant than the documents that have fewer matches.

For some embodiments, the documents that include the search parameters closer together may be considered to be more relevant than the documents that include the search parameters further apart. For example, the search parameters are “mountain” and “bike”, and the proximity criteria is “within the same sentence”. The search results in this example include two documents, the first document includes the sentence “Let's go buy a mountain bike.”, and the second document includes the sentence “I left my bike somewhere along the mountain trail.” The first document may be considered to be more relevant because the search parameters “mountain” and “bike” are closer to each other. The second document may be considered to be less relevant than the first document because the search parameters are separated by the phrase “somewhere along the”.

### Displaying Search Results Based on Order of Relevancy

For some embodiments, the documents included in the search results may be displayed in order of relevancy. This may be from most relevant to least relevant. Alternatively, it may be from least relevant to most relevant. The search results may be formatted to illustrate the search parameters that fall within a proximity range.

### Displaying Documents Based on Dominance

When a dominant search parameter is specified, the dominant search parameter may be displayed in a format that is different from the non-dominant search parameter. This may convey information that may not be obviously apparent in the document. For example, the dominant search parameter may be highlighted using one color, and the non-dominant search parameter may be highlighted using a different color. Furthermore, the color used for the non-dominant search parameter may vary with a gradient value of a color that diminishes in brightness according to distance from the dominant search parameter. This may enable a user to easily recognize the proximity relationships between the dominant search parameter and each of the non-dominant search parameters.

Displaying Search Results with Search Parameters Formatted

For some embodiments, the search parameters in the documents included in the search results may be formatted by styling the text or the text area. The text or the text area may have one or more of the following formats: bolded text, italic text, larger font, smaller font, different font, underlined text, highlighted text, patterns, colored text, text with image background, hyperlinks, markup tags, boxes, circles, numbers, symbols, etc. For example, when two key strings are found within the proximity threshold, the two key strings may be highlighted in yellow, so that it is easier for the user to find the results that match the query.

For some embodiments, HTML (Hypertext Markup Language) markup tags may be used with documents that are included in the search results for searches using the proximity criteria. This may allow other web services to find information within a document that may be more relevant to a particular topic or category.

Many prior search techniques require the user to carefully wade through every match within a document without any visual cues. Formatting the search parameters in the documents included in the search results may improve the process of visually searching through a document. The user may quickly recognize the formatted search parameters and determine the search parameters that are most relevant. This visual search technique may enable the user to save time to review the documents, making the review more efficient and meaningful.

### Increasing Search Results by Expanding Proximity Criteria

For some embodiments, the search engine may gradually expand the scope of the proximity criteria to increase the number of search results. This number of search results may be specified by the user. It may be set as a default value, or it may be determined automatically by the search engine based on previous searches by the user. For example, if there are few documents included in the search results that satisfy the proximity criteria “within the sentence”, the search engine may expand the proximity criteria to “within the paragraph” to increase the number of documents in the search results. If this does not provide a desired number of documents included in the search results, the search engine may progressively expand the proximity criteria until a desired number of documents included in the search results is reached or is feasible.

Increasing Search Results with Documents Not Meeting Proximity Criteria

The search engine may find documents that have the search parameters but the search parameters may not be positioned within the proximity specified by the proximity criteria. These documents may normally be excluded from the search results if the proximity criteria is strictly enforced. For some embodiments, these documents may optionally be included in the search results but they may be considered to be less relevant. For some embodiments, these documents may be included in the search results in a decreasing relevancy order with those that almost satisfy the proximity criteria considered to be more relevant.

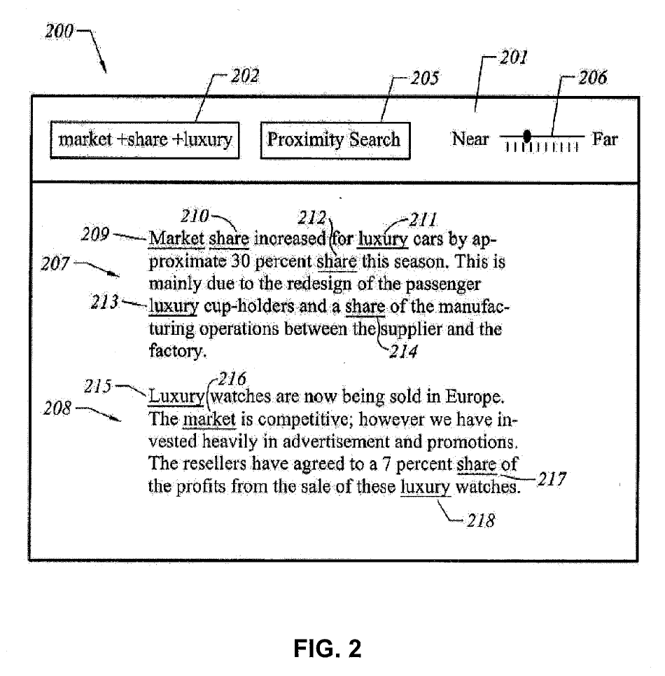

FIG. 2 illustrates an example of one technique of providing the proximity criteria, in accordance with some embodiments. Window 200 may include information that may be used by a search engine. The window 200 may be a browser window. The window 200 may include a tool bar 201 which may include a search input area 202 to enter the search parameters. The tool bar 201 may also include a proximity search selector 205 to activate proximity search, and proximity criteria selector 206 to indicate proximity criteria.

The toolbar 201 may enable a user to specify search options that can be used by a search engine. The search engine may search through an open document in window 200 to find matches.

For some embodiments, a first search parameter may be interpreted by the search engine as the dominant search parameter. The search engine may interpret the remaining search parameters as non-dominant search parameters. A separator may be used between the dominant search parameter and the non-dominant search parameters and between the non-dominant search parameters. In the current example, the dominant search parameter may be “market”, and the non-dominant search parameters may be “share” and “luxury”. The separator may be “+”, as illustrated in the search input area 202. The proximity criteria selector 206 in the current example is illustrated as a slider that may be set to a value within a range between “near” and “far”. Here, the slider is set to a value slightly to the left of the center of the range.

For some embodiments, when a range is used to specify the proximity criteria, the search engine may map a value in the range to proximity of the search parameters in the documents. For example, when the proximity criteria selector 206 is positioned slightly to the left of the center point of the range, the search engine may interpret this to be similar to “within a paragraph”. When the proximity criteria selector 206 is positioned to the far left of the range, the search engine may interpret this to be similar to “within a sentence.” Thus, a document may be included in the search results if the document has a sentence that has both the dominant search parameter and the non-dominant search parameter.

Referring to FIG. 2, after the search parameters are specified in the search input area 202, and the proximity criteria has been specified using the proximity criteria selector 206, the proximity search may be activated by selecting proximity search selector 205. The search engine may then start the search and analyze the open document using the search parameters specified in the search input area 202.

The search engine may then convert the proximity criteria specified by the proximity criteria selector 206 into an appropriate measurable proximity value (e.g., “within a paragraph”, “within a sentence”, etc.). In this example, the search engine may look for instances of carriage returns and/or line feeds that denote the start and the end of a paragraph in a document. The search engine may find and record the position of each search parameter within the document. Alternatively, the search engine may step through the document one search parameter at a time and determine the proximity with the other search parameters.

For some embodiments, the search engine may first record the position of every instance of every search parameter found in the document. This may include one or more of finding an absolute position of a search parameter in the document, an absolute position within a section, an absolute position within a paragraph, and an absolute position within a sentence. This may include one or more of finding a relative position of a search parameter within the document, a relative position within a section, a relative position within a paragraph, relative position within a sentence, and a relative position to another search parameter.

The search engine may evaluate each search parameter at a time. The search parameter under evaluation may be referred to as an anchor search parameter. The search parameter may then determine the proximity of the other search parameters from the anchor search parameter. When there is a dominant search parameter, the dominant search parameter may be the anchor search parameter. The search engine may then determine the proximity of the other non-dominant search parameters relative to the dominant search parameter.

The proximity value may be determined based on characters, words, paragraphs, or sections between the anchor search parameter and the other search parameters. If the proximity between the anchor search parameter and the other search parameters in the document is consistent with the proximity value, then the matches between the anchor search parameter and the other search parameters may be considered relevant. These search parameters may then be formatted for ease of recognition.

For some embodiments, the level of proximity among the search parameters may be used to rank the matches. In addition, the level of proximity may be used to affect the formatting of different matches.

For some embodiments, the search engine may incorporate factors relating to the type styles of the search parameters to determine ranking of the documents included in the search results. These factors may include finding search parameters that are in all capital letters, whole words, italic, etc.

For some embodiments, the search engine may apply Boolean functions (e.g., AND, OR, NOT, etc.) to the type styles in its ranking of the matches. For example, when two search parameters are found within the proximity (e.g., within a sentence) of each other, and they are both in capital letters, the search parameters may be highlighted in a color that may be considered to rank higher than another color.

After the search engine considers each of the anchor search parameters and determines the proximity value to the other search parameters, the search engine may style the matches according to a predetermined format. Alternatively, the user may have the option to determine the style format that may be used by the search engine. For example, the dominant search parameter may be displayed as a solid color, and the non-dominant search parameter may be displayed in a different solid color that varies in brightness depending on how far the non-dominant search parameter is away from the dominant search parameter. Search parameters that do not satisfy the proximity criteria may not be formatted, or they may all be highlighted in a designated color.

In the example illustrated in FIG. 2, there are three search parameters “market”, “share” and “luxury”. The search parameters “market” may be designated as a dominant search parameter. The proximity criteria selector 206 indicates the proximity value to be “within a sentence”, as described above. In the paragraph 207, the dominant search parameter “market” 209 is positioned in the same sentence with the non-dominant search parameters “share” 210, “luxury” 211, “share” 212, “luxury” 213, and a second instance of “share” 214. In the paragraph 208, the dominant search parameter “market” 216 is not positioned in the same sentence with the non-dominant search parameter “luxury” 215, “share” 217, and “luxury” 218. Thus the first instance of the dominant search parameter “market” 209 would be the only match in these two paragraphs that agree with the proximity criteria.

It may be noted that in situations when the non-dominant search parameters are found in the same document, they may not be considered to be matches because they may not be positioned within the proximity of the dominant search parameter.

### Proximity Criteria in Search Box

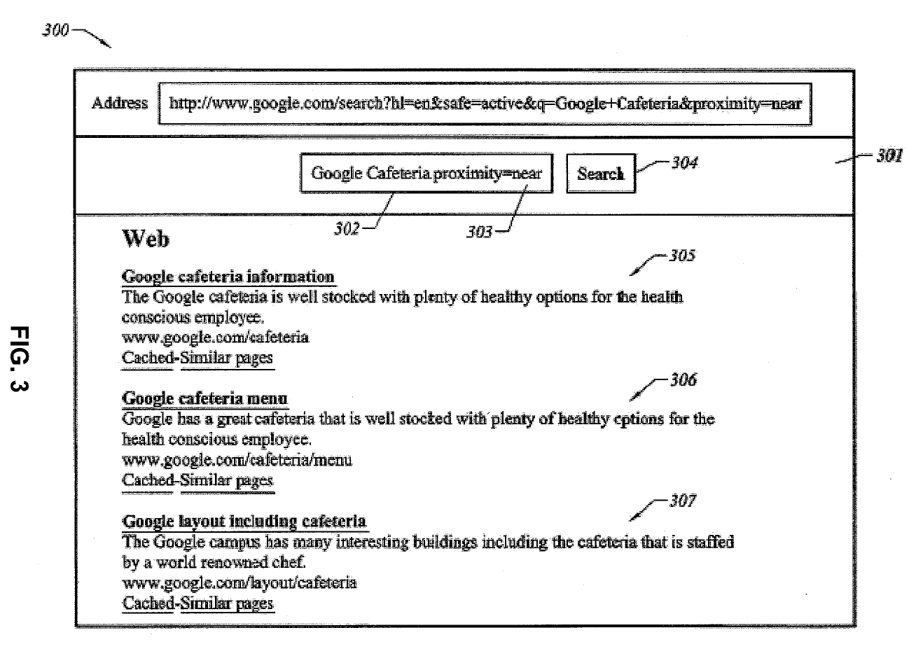

FIG. 3 illustrates an example of another technique of providing the proximity criteria, in accordance with some embodiment. Window 300 may include information that may be used by a search engine. The window 300 may be a browser window. The window 300 may include a tool bar 301 which may include a search input area 302 to enter the search parameters. The tool bar 301 may also include a search selector 304 to enable a user to initiate a search. For example, the window 300 includes information associated with a web page of a search service company such as Google, Inc.

For some embodiments, information that may be used by a search engine to perform a proximity search may be entered in the same input area as the search parameters. The information may include one or more search parameters, the proximity search indication, and the proximity criteria. Referring to the window 300, the two search parameters entered in the search input area 302 are “Google” and “Cafeteria”. The search engine may interpret that the search parameters are separated from each other by spaces. The search engine may recognize that it is to perform a proximity search when the phrase “proximity=near” 303 is detected in the search input area 302. For example, when the proximity “near” corresponds to a proximity value of “within the same sentence”, the search engine is to find documents having the search parameters within the same sentence and include those documents in the search results.

The search results may be displayed within the window 300. In this example, the search results include results 305, 306 and 307 which may be displayed in a certain order. One such order is the relevancy order where a result with more matches may be considered more relevant and therefore may be displayed before a result with fewer matches. Other orders may also be used. In the current example, the display of each of the results 305, 306 and 307 includes a unique resource locator (URL) linking to a document or to a web page.

As illustrated, the result 305 may be displayed first since it includes the search parameters “Google” and “Cafeteria” with the closest proximity. Both of the search parameters are positioned next to each other in the same sentence that is displayed with the result 305. The result 306 is displayed next since it includes both of the search parameters in the same sentence but separated by the phrase “has a great”. The result 307 includes both of the search parameters in the same sentence but is displayed last because it is separated by a longer phrase “campus has many interesting buildings including the”. When displaying the results in order, a user may easily recognize that the result 305 is considered to be the most relevant result, the result 306 may be less relevant, and the result 307 may be least relevant among the three results 305-307.

For some embodiments, when the search engine is configured to display all of the documents that include both of the search parameters, the search engine may progressively expand the proximity criteria until all of the possible matches are found. Alternatively, the search engine may determine proximity for all documents that include the search parameters and then rank them in the order of “closest” to “furthest” relevancy.

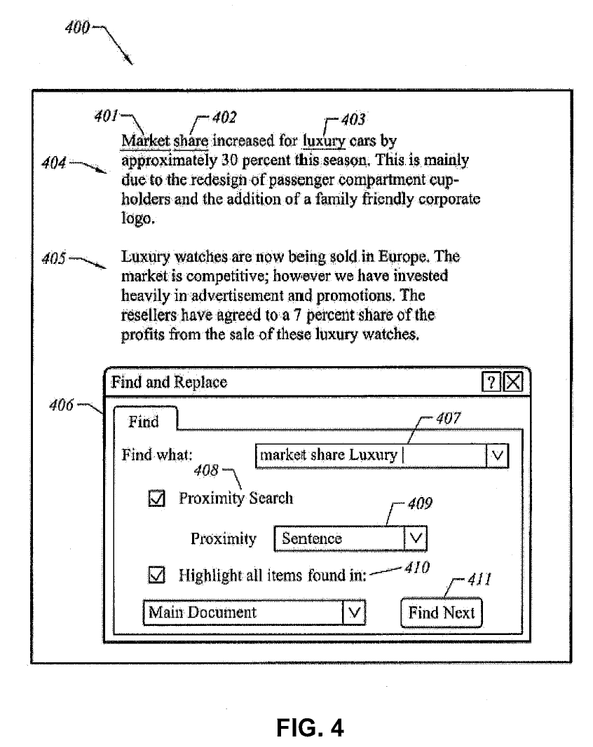

FIG. 4 is an example that illustrates using proximity search in an application window, in accordance with some embodiments. Window 400 may be associated with an application such as, for example, a word processor. The application may enable a document to be displayed and may include a search function to search for information included in the document.

The window 400 may be different from the window 300 (illustrated in FIG. 3) in that the window 400 displays content of a document as compared to a URL and some information of a document in the window 300. The content of the document in the window 400 in this example includes two paragraphs. The window 400 may also display a search window 406, which may be a pop-up window that becomes visible after the user selects a search selector (not shown). The search window 406 may include search parameter input area 407, proximity search indicator 408, and proximity criteria input area 409.

In the current example, the search parameter input area 407 includes search parameters “market”, “share”, and “luxury”. The proximity search indicator 408 is activated (e.g., by setting the associated check box) to indicate that a proximity search is to be performed by the search engine. The proximity criteria input area 409 includes the proximity value of “sentence”, indicating that when the search parameters are found within the same sentence, there is a match. The proximity criteria input area 409 is also activated using the check box to indicate to the search engine that it is to take the proximity value “sentence” into consideration. The search engine may interpret spaces between the search parameters as separators and the search parameters are to be considered individually.

The search window 406 may also include a search parameter highlight indicator 410, which when activated may cause the search engine to highlight the search parameters when there is a match. The search window 406 may also include a “find next” selector 411 to enable searching for the next matches. Referring to the paragraph 404 in FIG. 4, the search parameters “market” 401, “share” 402 and “luxury” 403 have been underlined or highlighted to indicate that there is a match. This is because all of these search parameters are found in the same sentence, consistent with the desired proximity value specified in the proximity criteria input area 409. It may be noted that the example uses underlining as one technique of formatting. Other techniques may also be used. For example, the highlighting may be done using colors. Referring to paragraph 405 of FIG. 4, even though the search parameters are found in the paragraph 405, none of the search parameters is highlighted. This is because the search parameters are not positioned in the same sentence. Applying the proximity search to documents may enable easier and more efficient reviewing and editing of documents.

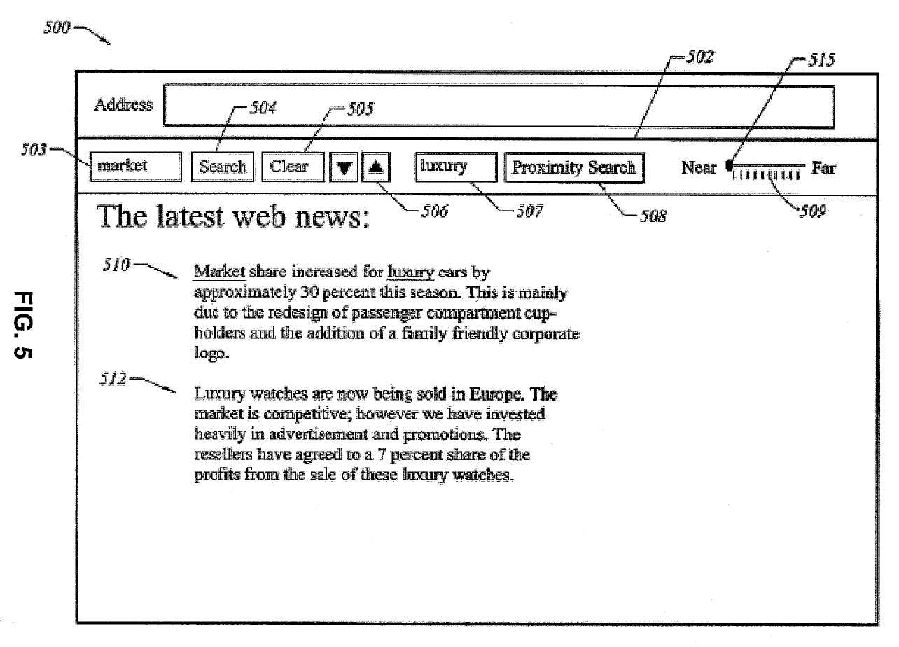

FIG. 5 is an example that illustrates using proximity search in a browser window, in accordance with some embodiments. Browser window 500 may include tool bar 502. In the current example, the tool bar 502 is positioned horizontally across the top portion of the browser window 500. The tool bar 502 may also be positioned elsewhere within the browser window 500.

The toolbar 502 may include options that may be used by a search engine. The search may be performed on a document (e.g., document 501) opened within the browser window 500. The toolbar 502 may include a dominant search parameter input box 503, a non-dominant search parameter input box 507, proximity search selector 508, and proximity criteria selector 509.

The non-dominant search parameter input box 507 may be used to enter one or more search parameters. A space between the search parameters may be used as a separator. In the current example, there is one dominant search parameter “market” in the dominant search parameter input box 503, and there is one non-dominant search parameter “luxury” in the non-dominant search parameter input box 507.

The proximity criteria selector 509 includes a slider 515 that may be set to a proximity value ranging from “near” to “far”. In the current example, the slider 515 is set to “near” which may be interpreted by the search engine as finding the search parameters “market” and “luxury” that are within the same sentence. A “far” setting may correspond to finding search parameters that are within the same document. The search engine may start performing the proximity search when the proximity search selector 508 is activated.

The search engine may recognize the existence of the dominant search parameter “market” in the dominant search parameter input box 503. The search engine may find one or more the dominant search parameter “market” in the document 501. For each instance of the dominant search parameter “market”, the search engine may determine the proximity to each non-dominant search parameter “luxury” found in the document 501.

Referring to paragraph 510, there is a match in the first sentence because the dominant search parameter “market” is in the same sentence as the non-dominant search parameter “luxury”. These two search parameters are formatted by underlining. Other formatting techniques may also be used. The formatting techniques may enable the dominant search parameter and the non-dominant search parameter to become more visible.

Referring to paragraph 512, there is no relevant match because the dominant search parameter “market” and the non-dominant search parameter “luxury” are positioned in different sentences.

The tool bar 502 may include a “find previous match” and “find next match” selector 506. This may be convenient when there are multiple matches.

The tool bar 502 may also include a “clear” selector 505. This may be used to clear the formatting of the matches. For example, when the “clear” selector 505 is activated, the underlining of the search parameters “market” and “luxury” in the paragraph 510 may disappear.

It may be noted that the tool bar 502 also include search selector 504. Activating the search selector 504 may enable the search engine to perform a standard search instead of a proximity search. In this situation, the search engine may ignore the proximity criteria.

The options described with the tool bar 502 may greatly increase the utility of the search engine when used with a browser window. The formatted search parameters make document review and inspection more efficient.

### System

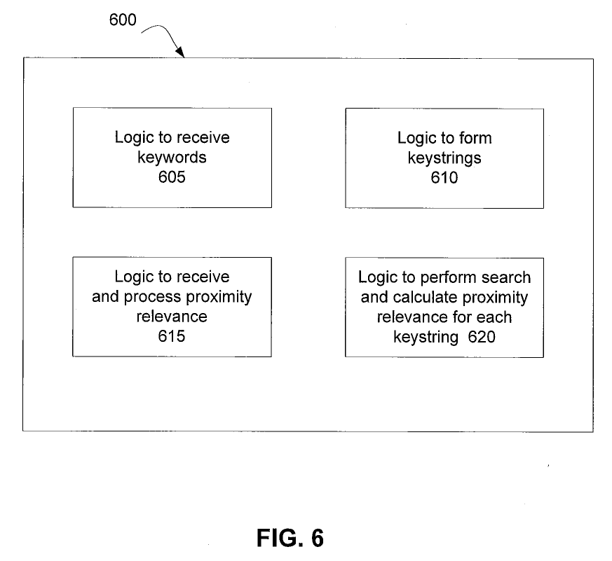

FIG. 6 illustrates an example of a computer system that includes logic that may be used, in accordance with some embodiments. In this example, computer system 600 may include logic 605 to receive information relating to one or more search parameters. The information may be entered by a user or entered automatically through some other input techniques. The information may then be processed by logic 610 which may separate the information into search parameters. For example, the logic 610 may use spaces as separators to identify the search parameters. The computer 600 may receive the proximity criteria. The proximity criteria may be entered by a user or by some other input techniques. The proximity criteria may be received by logic 615 which may process it together with the search parameters formed by the logic 610. Logic 620 may be coupled to the logic 615 and may be used to perform a search using the proximity criteria and the search parameters. Each of the logic described in FIG. 6 may also be associated with a corresponding module implemented in software, hardware or a combination of both.

### Network

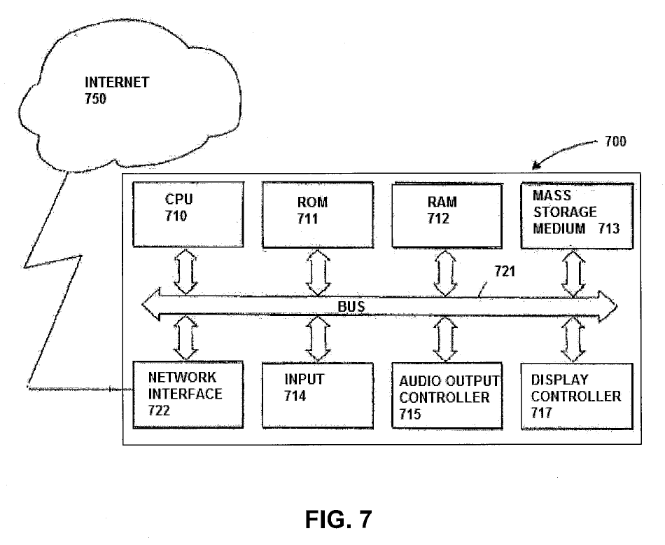

FIG. 7 illustrates an example of a system that may be used to perform search operations when connected to a network such as, for example, the Internet, in accordance with some embodiments. Computer system 700 may be used by a user to search for information based on search parameters. The computer system 700 may include a central processing unit (CPU) 710, read only memory (ROM) 711, random access memory (RAM) 712, mass storage medium 713, all connected to bus 721. When the techniques described above is implemented in software, the software may be stored in one or more of the mass storage medium 713, the RAM 712, and the ROM 711. The computer system 700 may also include input interface 714, audio output controller 715 and display controller 717. One or more of the devices 714-717 may be used by the user to enter the search parameters. The computer system 700 may also include network interface 722 coupled to the bus 721. The network interface 722 may be used to connect to a network such as a local area network (LAN), a wide area network (WAN), etc. In the current example, the network interface 722 may be used to enable the user to connect to the Internet 750 when the user desires to use the Internet 750 to search for documents based on the search parameters entered.

Embodiments of methods and systems for searching using proximity criteria are described herein. In the above description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring the description.

Thus, embodiments of this invention may be used as or to support software program executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the abstract, is not intended to be exhaustive or to be limitation to the precise forms disclosed. While specific embodiments of, and examples for, the invention are described herein for illustrative purposes, various equivalent modifications are possible, as those skilled in the relevant art will recognize. For example, the search threshold information may be used to search for documents stored on the users' computer or stored on a network storage device that the user's computer is connected to.

These modifications can be made to embodiments of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation.

What is claimed is:

1. A method, comprising:
receiving search parameters;
receiving proximity criteria to be used with the search parameters; and
initiating a search using the search parameters and the proximity criteria.

2. The method of claim 1, wherein the proximity criteria is determined automatically.

3. The method of claim 1, wherein the proximity criteria is specified by a user.

4. The method of claim 1, further comprising:
when the search parameters are found in a document, determining if the positions of the search parameters are consistent with the proximity criteria.

5. The method of claim 4, further comprising:
when the search parameters are consistent with the proximity criteria, identifying the document as being relevant.

6. The method of claim 5, wherein the search parameters that are consistent with the proximity criteria are formatted.

7. The method of claim 6, wherein a first document is considered to be more relevant than a second document when the first document includes more instances of the search parameters that are consistent with the proximity criteria.

8. The method of claim 7, wherein the search is performed by a search engine associated with a web site.

9. The method of claim 8, wherein the first document and the second document are displayed according to a relevancy order.

10. The method of claim 9, wherein universal resource locator (URL) of each of the first document and the second document is displayed.

11. The method of claim 6, wherein a first instance of the search parameters is more relevant than a second instance of the search parameters when the search parameters have closer proximity in the first instance than in the second instance.

12. The method of claim 6, wherein one of the search parameters is a dominant search parameter, and wherein the proximity criterion is applied based on the dominant search parameter.

13. A search interface, comprising:
a search parameter input area to accommodate one or more search parameters;
a proximity criteria area to accommodate proximity criteria associated with the search parameters; and
a proximity search selector to enable initiating a proximity search using the search parameters and the proximity criteria.

14. The search interface of claim 13, wherein the search parameter input area comprises a dominant search parameter input area and a non-dominant search parameter input area.

15. The search interface of claim 13, further comprising:
a search selector to enable initiating a search using only the search parameters and not the proximity criteria.

16. The search interface of claim 13, further comprising:
a style selector to enable formatting the search parameters in a document when the search parameters are positioned consistently with the proximity criteria.

17. A system, comprising:
logic to receive two or more search parameters;
logic to receive proximity criteria to be used with the search parameters; and
logic to perform a search for documents that include the search parameters that satisfy the proximity criteria.

18. The system of claim 17, further comprising:
logic to rank documents according to relevancy order, wherein a first document with more instances of the search parameters that satisfy the proximity criteria is more relevant than a second document that has fewer instances.

19. The system of claim 18, further comprising:
logic to format the search parameters that satisfy the proximity criteria.

20. The system of claim 19, wherein the search parameters include a dominant search parameter and one or more non-dominant search parameters, and wherein the proximity criteria is based on the dominant search parameter.
